(19) United States
(12) Patent Application Publication
(10) Pub. No.: US 2020/0407382 A1
(43) Pub. Date: Dec. 31, 2020

(54) POLYMORPHIC FORMS OF (9-[(R)-2-[[(S)-[[(S)-1-(ISOPROPOXYCARBONYL)ETHYL]AMINO]PHENOXY PHOSPHINYL]METHOXY]PROPYL] ADENINE AND PHARMACEUTICALLY ACCEPTABLE SALTS THEREOF

(71) Applicant: CIPLA LIMITED, Mumbai, Maharashtra (IN)

(72) Inventors: Dharmaraj Ramachandra RAO, Thane, Maharashtra (IN); Geena MALHOTRA, Mumbai, Maharashtra (IN); Srinivas Laxminarayan PATHI, Bangalore, Karnataka (IN); Manjinder Singh PHULL, Mumbai, Maharashtra (IN); Ramanaiah CHENNURU, Nellore (Dt), Andhra Pradesh (IN)

(21) Appl. No.: 16/959,205

(22) PCT Filed: Dec. 28, 2018
(86) PCT No.: PCT/IN2018/050891

§ 371 Date: Jun. 30, 2020

(30) Foreign Application Priority Data
Dec. 30, 2017 (IN) 201721047383

(51) Int. Cl. C07F 9/6558

(52) U.S. Cl. CPC C07F 9/65583; C07B 2200/13

(57) ABSTRACT

The present invention discloses novel crystalline polymorphic forms of (9-[(R)-2-[[(S)-[[(S)-1-(isopropoxy carbonyl) ethyl] amino] phenoxyphosphinyl] methoxy]propyl] adenine hemifumarate and 9-[(R)-2-[[(S)-[[(S)-1-(isopropoxycarbonyl)ethyl] amino]phenoxy phosphinyl]methoxy]propyl] adenine monofumarate, methods of preparation, pharmaceutical compositions and methods of therapeutic treatment involving polymorphic forms thereof.

### FIELD OF THE INVENTION

The invention encompasses polymorphic forms of (9-[(R)-2-[[(S)-[[(S)-1-(isopropoxycarbonyl) ethyl] amino] phenoxy phosphinyl]methoxy]propyl] adenine and pharmaceutically acceptable salts thereof/TAF polymorph, as well as processes for the preparation thereof.

### BACKGROUND OF THE INVENTION

(9-[(R)-2-[[(S)-[[(S)-1-(isopropoxycarbonyl)ethyl]amino]phenoxyphosphinyl] methoxy]propyl] adenine is a nucleotide reverse transcriptase inhibitor and a prodrug of (R)-9-(2-phosphonomethoxypropyl)adenine. (9-[(R)-2-[[(S)-[[(S)-1-(isopropoxycarbonyl)ethyl]amino] phenoxyphosphinyl] methoxy]propyl] adenine per se is protected by U.S. Pat. No. 7,390,791 owned by Gilead Sciences, for use in the treatment of HIV infection and chronic hepatitis B, and is further protected in the form of (9-[(R)-2-[[(S)-[[(S)-1-(isopropoxycarbonyl)ethyl]amino] phenoxyphosphinyl] methoxy]propyl] adenine fumarate (TAF). The U.S. Pat. No. 7,390,791 also discloses a monofumarate form of this compound and its preparation method (see, e.g., Example 4) and has the following chemical formula (I):

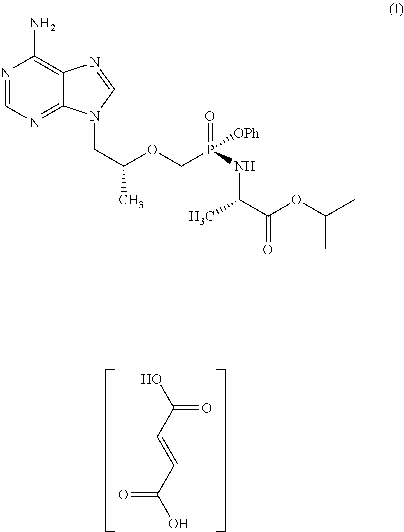

Pharmaceutical solids can exist in different crystal forms, such as crystalline, amorphous, or glass and also in solvated or hydrated states (Haleblian et al., 1969,1975; Kuhnert-Brandstaetter, 1973; Sohn 2004). Polymorphism is the ability of any element or compound to crystallize as more than one distinct crystal species.

Polymorphism has been observed for (9-[(R)-2-[[(S)-[[(S)-1-(isopropoxycarbonyl) ethyl]amino] phenoxyphosphinyl] methoxy]propyl] adenine and salts thereof.

The U.S. Pat. No. 8,754,065 B2 describes crystalline form of (9-[(R)-2-[[(S)-[[(S)-1-(isopropoxycarbonyl)ethyl]amino] phenoxyphosphinyl] methoxy]propyl] adenine hemifumarate (II)

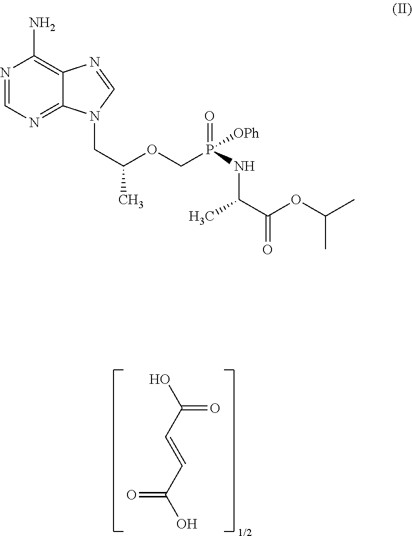

and characterised by XRD, DSC, TGA and DVS.

The patent application publication WO 2017/203395 A1, describes crystalline form of (9-[(R)-2-[[(S)-[[(S)-1-(isopropoxycarbonyl)ethyl]amino] phenoxyphosphinyl] methoxy]propyl] adenine hemifumarate “Form-STA” characterised by XRD and DSC.

The indian patent application IN 201641001993, describes crystalline form of (9-[(R)-2-[[(S)-[[(S)-1-(isopropoxycarbonyl)ethyl]amino] phenoxyphosphinyl] methoxy]propyl] adenine hemifumarate “Form G” characterised by XRD and DSC.

The discovery of new polymorphic forms of a pharmaceutically useful compound provides a new opportunity to improve the performance characteristics of a pharmaceutical product. It enlarges the repertoire of materials that a formulation scientist can avail for designing, for example, a pharmaceutical dosage form of a drug with a targeted release profile or other desired characteristic.

It is a well known fact that different polymorphic forms of the same drug may have substantial differences in certain pharmaceutically-important physicochemical properties, such as stability, solubility, dissolution rate, crystal habit, tableting behavior. Changes in certain of these physiochemical properties may ultimately affect the bioavailability of the drug. Furthermore, different physical forms may have different particle size, hardness and glass transition temperatures. In certain cases, this phenomenon may affect the quality and performance of the final dosage form.

Regulatory authorities desire to have all possible polymorphic forms of a new drug substance identified prior to approval of a product containing the drug. However, as is well known in the art, the existence of polymorphic forms of any given compound cannot be predicted, and there is no standard procedure for proceeding to make a previously unknown polymorphic form. Even after a polymorph has been identified, there is no possibility of predicting whether any additional forms will ever be discovered. This has been described in many recent articles, including A. Goho, Science News, Vol. 166, No. 8, pages 122-123 (August 2004).

Consequently, it would be a significant contribution to the art to provide novel forms of (9-[(R)-2-[[(S)-[[(S)-1-(isopropoxycarbonyl)ethyl]amino] phenoxyphosphinyl] methoxy]propyl] adenine and pharmaceutically acceptable salts thereof, having increased solubility, and methods of preparation, pharmaceutical formulations, and methods of use thereof.

### Objects of the Invention

An object of the present invention is to provide various polymorphic forms of (9-[(R)-2-[[(S)-[[(S)-1-(isopropoxycarbonyl)ethyl]amino] phenoxyphosphinyl] methoxy]propyl] adenine and pharmaceutically acceptable salts thereof.

Another object of the present invention is to provide processes for the preparation of novel polymorphic forms of (9-[(R)-2-[[(S)-[[(S)-1-(isopropoxycarbonyl)ethyl]amino] phenoxyphosphinyl] methoxy]propyl] adenine and pharmaceutically acceptable salts thereof.

Yet another object of the invention is to provide pharmaceutical composition comprising a therapeutically effective amount of novel forms of (9-[(R)-2-[[(S)-[[(S)-1-(isopropoxycarbonyl)ethyl]amino] phenoxyphosphinyl] methoxy]propyl] adenine and pharmaceutically acceptable salts thereof.

Yet another object of the invention is to provide method of treatment of diseases or symptoms of HIV, wherein novel forms of (9-[(R)-2-[[(S)-[[(S)-1-(isopropoxycarbonyl)ethyl]amino] phenoxyphosphinyl] methoxy]propyl] adenine and pharmaceutically acceptable salts thereof, are useful.

Yet another object of the invention is to provide an industrially advantageous, cost effective and environmentally friendly process for preparing highly pure (9-[(R)-2-[[(S)-[[(S)-1-(isopropoxycarbonyl)ethyl]amino] phenoxyphosphinyl] methoxy]propyl] adenine and pharmaceutically acceptable salts thereof in high yields.

### SUMMARY OF THE INVENTION

The present invention provides novel polymorphic forms of (9-[(R)-2-[[(S)-[[(S)-1-(isopropoxycarbonyl) ethyl]amino] phenoxyphosphinyl] methoxy]propyl] adenine and pharmaceutically acceptable salts thereof.

More preferably, the invention provides novel polymorphic forms of (9-[(R)-2-[[(S)-[[(S)- 1-(isopropoxycarbonyl) ethyl]amino] phenoxyphosphinyl] methoxy]propyl] adenine hemi fumarate compound (II) and (9-[(R)-2-[[(S)-[[(S)-1-(isopropoxycarbonyl) ethyl]amino] phenoxyphosphinyl] methoxy]propyl] adenine monofumarate compound (I).

Particularly preferred polymorphic forms of hemi fumarate salts of the present invention are those compounds designated herein as “Form C1 (anhydrous Form)” “Form C2 (anhydrous Form)”, “Form C3 (anhydrous Form)”, “Form C4 (anhydrous Form)”, “Form C5 (ethyl formate solvate)”, “Form C6 (anhydrous Form)”, “Form C7(methyl acetate solvate)”, “Form C8 (anhydrous Form)” and “Form C9 (anhydrous Form)”.

Particularly preferred polymorphic forms of monofumarate salts of the present invention are those compounds designated herein as “Form C4 (anhydrous Form)”.

The novel polymorphic forms of the present invention are characterized by unique PXRD patterns.

In another aspect, the present invention relates to processes for preparing novel polymorphic forms of (9-[(R)-2-[[(S)-[[(S)-1-(isopropoxycarbonyl) ethyl]amino] phenoxyphosphinyl] methoxy]propyl] adenine and pharmaceutically acceptable salts thereof.

In another embodiment, the invention encompasses a pharmaceutical formulation comprising a therapeutically effective amount of at least one of the above described forms of (9-[(R)-2-[[(S)-[[(S)-1-(isopropoxycarbonyl) ethyl]amino] phenoxyphosphinyl] methoxy]propyl] adenine and pharmaceutically acceptable salts thereof and at least one pharmaceutically acceptable excipient.

In yet another embodiment, the invention encompasses a process for preparing a pharmaceutical formulation comprising combining at least one of the above-described forms of (9-[(R)-2-[[(S)-[[(S)-1-(isopropoxycarbonyl) ethyl]amino] phenoxyphosphinyl] methoxy]propyl] adenine and pharmaceutically acceptable salts thereof, with at least one pharmaceutically acceptable excipient.

In one embodiment, the invention encompasses use of a pharmaceutical formulation comprising a therapeutically effective amount of at least one of the above described crystalline forms of (9-[(R)-2-[[(S)-[[(S)-1-(isopropoxycarbonyl) ethyl]amino]phenoxyphosphinyl] methoxy]propyl] adenine and pharmaceutically acceptable salts thereof, and at least one pharmaceutically acceptable excipient in the manufacture of a pharmaceutical composition.

In another embodiment, the invention encompasses methods of treating or preventing HIV comprising administering a pharmaceutical formulation comprising a therapeutically effective amount of at least one of the above-described forms of (9-[(R)-2-[[(S)-[[(S)-1-(isopropoxycarbonyl) ethyl]amino] phenoxyphosphinyl] methoxy]propyl] adenine and pharmaceutically acceptable salts thereof, and at least one pharmaceutically acceptable excipient to a patient in need thereof.

### BRIEF DESCRIPTION OF THE DRAWINGS

FIG. 1 illustrates an X-ray powder diffraction pattern of Form C1 of (9-[(R)-2-[[(S)-[[(S)-1-(isopropoxycarbonyl)ethyl]amino] phenoxyphosphinyl] methoxy]propyl] adenine hemifumarate.

FIG. 2 illustrates an X-ray powder diffraction pattern of Form C2 of (9-[(R)-2-[[(S)-[[(S)-1-(isopropoxycarbonyl)ethyl]amino] phenoxyphosphinyl] methoxy]propyl] adenine hemifumarate.

FIG. 3 illustrates an X-ray powder diffraction pattern of Form C3 of (9-[(R)-2-[[(S)-[[(S)-1-(isopropoxycarbonyl)ethyl]amino] phenoxyphosphinyl] methoxy]propyl] adenine hemifumarate.

FIG. 4 illustrates an X-ray powder diffraction pattern of Form C4 of (9-[(R)-2-[[(S)-[[(S)-1-(isopropoxycarbonyl)ethyl]amino] phenoxyphosphinyl] methoxy]propyl] adenine hemifumarate.

FIG. 5 illustrates an X-ray powder diffraction pattern of Form C5 of (9-[(R)-2-[[(S)-[[(S)-1-(isopropoxycarbonyl)ethyl]amino] phenoxyphosphinyl] methoxy]propyl] adenine hemifumarate.

FIG. 6 illustrates an X-ray powder diffraction pattern of Form C6 of (9-[(R)-2-[[(S)-[[(S)-1-(isopropoxycarbonyl)ethyl]amino] phenoxyphosphinyl] methoxy]propyl] adenine hemifumarate.

FIG. 7 illustrates an X-ray powder diffraction pattern of Form C7 of (9-[(R)-2-[[(S)-[[(S)-1-(isopropoxycarbonyl)ethyl]amino] phenoxyphosphinyl] methoxy]propyl] adenine hemifumarate.

FIG. 8 illustrates an X-ray powder diffraction pattern of Form C8 of (9-[(R)-2-[[(S)-[[(S)-1-(isopropoxycarbonyl)ethyl]amino] phenoxyphosphinyl] methoxy]propyl] adenine hemifumarate.

FIG. 9 illustrates an X-ray powder diffraction pattern of Form C9 of (9-[(R)-2-[[(S)-[[(S)-1-(isopropoxycarbonyl)ethyl]amino] phenoxyphosphinyl] methoxy]propyl] adenine monofumarate.

FIG. 10 illustrates a dynamic vapor sorption (DVS) isotherm profile of Form C4 of (9-[(R)-2-[[(S)-[[(S)-1-(isopropoxycarbonyl)ethyl]amino] phenoxyphosphinyl] methoxy]propyl] adenine hemifumarate.

FIG. 11 illustrates a Solid-state ¹³C nuclear magnetic resonance spectrum (ss-NMR) with spinning side bands identified by an asterisk of Form C4 of (9-[(R)-2-[[(S)-[[(S)-1-(isopropoxycarbonyl)ethyl]amino] phenoxyphosphinyl] methoxy]propyl] adenine hemifumarate.

### DETAILED DESCRIPTION OF THE INVENTION

The present invention provides novel polymorphic forms of (9-[(R)-2-[[(S)-[[(S)-1-(isopropoxy carbonyl) ethyl] amino] phenoxyphosphinyl] methoxy]propyl] adenine and pharmaceutically acceptable salts thereof. More preferably the invention provides novel polymorphic forms of (9-[(R)-2-[[(S)-[[(S)-1-(isopropoxycarbonyl) ethyl]amino] phenoxyphosphinyl] methoxy]propyl] adenine hemifumarate compound (II) and (9-[(R)-2-[[(S)-[[(S)-1-(isopropoxycarbonyl) ethyl]amino] phenoxyphos phinyl] methoxy]propyl] adenine monofumarate compound (I).

Techniques for characterizing polymorphic forms include, but are not limited to, X-ray powder diffractometry (XRPD), differential scanning calorimetry (DSC), thermal gravimetric analysis (TGA), single-crystal X-ray diffractometry (XRD), vibrational spectroscopy, e.g., infrared (IR) and Raman spectroscopy, Solid state and solution nuclear magnetic resonance (NMR) spectroscopy, optical microscopy, hot stage optical microscopy, scanning electron microscopy (SEM), electron crystallography and quantitative analysis, particle size analysis (PSA), Surface area analysis, Solubility measurements, dissolution measurements, elemental analysis and Karl Fischer analysis.

As used herein in connection with a measured quantity, the term “about” refers to that variation in the measured quantity as would be expected by the skilled artisan performing the measurement and exercising a level of care commensurate with the objective of the measurement and the precision of the measuring apparatus being used.

As used herein, the term “substantially the same X-ray powder diffraction pattern” is understood to mean that those X-ray powder diffraction patterns having diffraction peaks with 2θ values within ±0.2° of the diffraction pattern referred to herein are within the scope of the referred to diffraction pattern.

As used herein, the term “room temperature” or “RT” refers the ambient temperature of a typical laboratory, which is usually about 15° C. to about 30° C., often about 20° C. to about 25° C.

As used herein, the term “over night” refers to a period of time of about 6 hours to about 24 hours, preferably, of about 10 to about 20 hours.

As used herein, the term “reflux temperature” refers to the boiling point of the solvent or mixture being heated.

As used herein, the term “vacuum” or “reduced pressure” refers to a pressure of about to 2 mmHg to about 100 mmHg.

As used herein, the term “solvate” refers to an association or complex of one or more solvent molecules and a compound of the invention. Such solvents for the purpose of the invention may not interfere with the biological activity of the solute. Typically, the solvent used is a pharmaceutically acceptable solvent. Examples of solvents that form solvates include, but are not limited to, water, C1-C4 alcohol solvents such as isopropanol, ethanol, methanol, dimethylsulfoxide (DMSO), ethyl acetate, acetic acid, ethyl formate, methyl acetate and ethanolamine.

The solvate can be isolated either as an amorphous form or in a crystalline form, preferably in crystalline form.

The solvate can be further isolated either in anhydrous form or hydrated form.

As used herein, the term “hydrate” refers to the complex where the solvent molecule is water. The skilled person will appreciate that the water molecules are absorbed, adsorbed or contained within a crystal lattice of the solid compounds, usually in defined stoichiometric ratio. The notation for a hydrated compound may be .nH₂O, where n is the number of water molecules per formula unit of the compound. For example, in a hemihydrate, n is 0.5; in a monohydrate n is one; in a sesquihydrate, n is 1.5; in a dihydrate, n is 2; and so on.

The novel polymorphs of the present invention may be isolated in pseudo polymorphic form as a solvate optionally in hydrated form, or as a non-hydrated solvate.

Accordingly, pseudo polymorphs provided include solvates, more in particular, ethyl formate, and methyl acetate, optionally in hydrated form.

As polymorphic forms are reliably characterized by peak positions in the X-ray diffractogram, the polymorphs of the present invention have been characterized by powder X-ray diffraction spectroscopy which produces a fingerprint of the particular crystalline form. Measurements of 2θ values are accurate to within ±0.2 degrees. All the powder diffraction patterns were measured on a Rigaku Dmax 2200 advanced X-ray powder diffractometer with a copper-K-α radiation source.

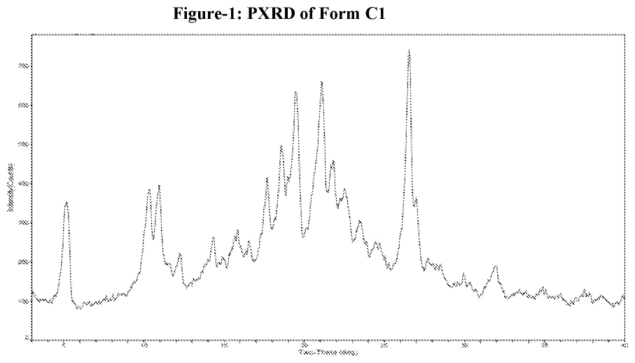

The invention encompasses a crystalline form of (9-[(R)-2-[[(S)-[[(S)-1-(isopropoxy carbonyl) ethyl] amino] phenoxyphosphinyl] methoxy]propyl] adenine hemifumarate, referred to as “Form C1”, characterized by having an XRPD diffractogram comprising peaks at 5.22, 10.34, 10.94, 17.7, 18.56, 19.48, 21.10 and 26.54±0.2° 2θ. The XRPD diffractogram may be as depicted in FIG. 1.

Preferably the crystalline Form C1 of (9-[(R)-2-[[(S)-[[(S)-1-(isopropoxy carbonyl) ethyl] amino] phenoxyphosphinyl] methoxy]propyl] adenine hemifumarate, has a crystalline purity of at least 80%, more preferably at least 90%, more preferably at least 95%, most preferably at least 99% by weight.

The invention encompasses a process for preparing the crystalline Form C1 of (9-[(R)-2-[[(S)-[[(S)-1-(isopropoxy carbonyl) ethyl] amino] phenoxyphosphinyl] methoxy]propyl] adenine hemi fumarate comprising: dissolving (9-[(R)-2-[[(S)-[[(S)-1-(isopropoxy carbonyl) ethyl] amino] phenoxyphosphinyl] methoxy]propyl] adenine hemifumarate in a solvent selected from the group comprising of ethanol, methanol, isopropyl alcohol (IPA) and or mixture thereof; adding a water-immiscible organic solvent to obtain a precipitate; and removing the solvent from the reaction mass to obtain a solid and drying the solid.

Preferably, the water-immiscible organic solvent is selected from the group comprising of halogenated aliphatic hydrocarbon, aromatic hydrocarbon, ester, ethers, halogenated aromatic hydrocarbon, and mixtures thereof. Preferably, the ester is selected from the group comprising of ethyl acetate, methyl acetate, butyl acetate, isopropyl acetate, and mixtures thereof. Preferably, the ether is selected from the group comprising of petroleum ether, diisopropyl ether and diethyl ether. Preferably, the halogenated aromatic hydrocarbon is chloro benzene. Preferably, the aromatic hydrocarbon is toluene and xylene. Preferably, the halogenated aliphatic hydrocarbon is selected from the group consisting of dichloromethane, chloroform, and mixtures thereof. Preferably, the water-immiscible organic solvent is selected from the group consisting of petroleum ether, dichloromethane, toluene, and mixtures thereof. More preferably, the water-immiscible organic solvent is petroleum ether.

Preferably, water-immiscible organic solvent is added at a temperature of about 20° C. to about 30° C., more preferably at about 25° C.

Preferably, the removal of solvent is by evaporation, more preferably under reduced pressure, to a temperature of about 40° C. to about 70° C., preferably about 50° C. to about 60° C.

The drying may be done in a vacuum oven to obtain Form C1. Preferably, the drying is for about 30 minutes to about 5 hours. Preferably, the drying is performed under vacuum at a temperature of about 30° C. to about 50° C.

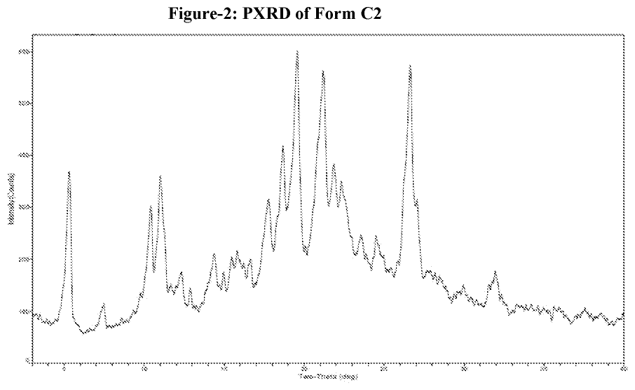

The invention encompasses a crystalline form of (9-[(R)-2-[[(S)-[[(S)-1-(isopropoxy carbonyl) ethyl] amino] phenoxyphosphinyl] methoxy]propyl] adenine hemifumarate, referred to as “Form C2”, characterized by having an XRPD diffractogram comprising peaks at 5.30, 7.47, 10.42, 11.02, 17.799, 18.68, 19.58, 21.20,21.86, 26.54 and 31.94±0.2° 2θ. The XRPD diffractogram may be as depicted in FIG. 2.

Preferably the crystalline Form C2 of (9-[(R)-2-[[(S)-[[(S)-1-(isopropoxy carbonyl) ethyl] amino] phenoxyphosphinyl] methoxy]propyl] adenine hemi fumarate, has a crystalline purity of at least 80%, more preferably at least 90%, more preferably at least 95%, most preferably at least 99% by weight.

The invention encompasses a process for preparing the crystalline Form C2 of (9-[(R)-2-[[(S)-[[(S)-1-(isopropoxy carbonyl) ethyl] amino] phenoxyphosphinyl] methoxy]propyl] adenine hemi fumarate comprising: dissolving (9-[(R)-2-[[(S)-[[(S)-1-(isopropoxy carbonyl) ethyl] amino] phenoxyphosphinyl] methoxy]propyl] adenine hemifumarate in solvent selected from the group comprising of ethanol, methanol, isopropyl alcohol (IPA) and or mixture thereof ; adding a water-immiscible organic solvent to obtain a precipitate; removing the solvent from the reaction mass to obtain a solid and drying the solid.

Preferably, the water-immiscible organic solvent is selected from the group comprising of halogenated aliphatic hydrocarbon, aromatic hydrocarbon, ester, ethers, halogenated aromatic hydrocarbon, and mixtures thereof. Preferably, the ester is selected from the group comprising of ethyl acetate, methyl acetate, butyl acetate, isopropyl acetate, and mixtures thereof. Preferably, the ether is selected from the group comprising of petroleum ether, diisopropyl ether and diethyl ether.

Preferably, the halogenated aromatic hydrocarbon is chloro benzene. Preferably, the aromatic hydrocarbon is selected from the group comprising of toluene and xylene. Preferably, the halogenated aliphatic hydrocarbon is selected from the group consisting of dichloromethane, chloroform, and mixtures thereof. Preferably, the water-immiscible organic solvent is selected from the group consisting of petroleum ether, dichloromethane, toluene, and mixtures thereof. More preferably, the water-immiscible organic solvent is petroleum ether.

Preferably, water-immiscible organic solvent is added at a temperature of about 20° C. to about 30° C., more preferably at about 25° C.

Preferably, the removal is by evaporation, more preferably under reduced pressure, to a temperature of about 40° C. to about 70° C., preferably about 50° C. to about 60° C.

The drying may be done in a vacuum oven to obtain Form C2. Preferably, the drying is for about 30 minutes to about 15 hours. Preferably, the drying is performed under vacuum at a temperature of about 30° C. to about 50° C.

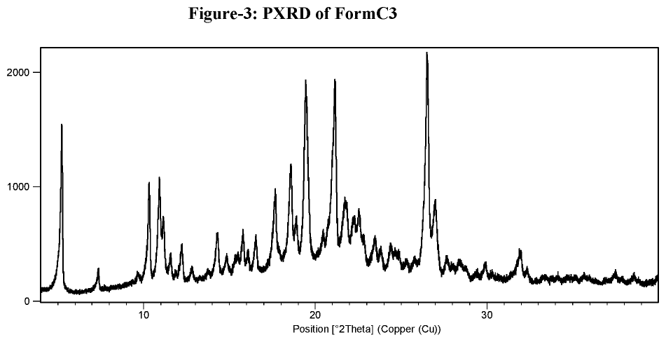

The invention encompasses a crystalline form of (9-[(R)-2-[[(S)-[[(S)-1-(isopropoxy carbonyl) ethyl] amino] phenoxyphosphinyl] methoxy]propyl] adenine hemifumarate, referred to as “Form C3”, characterized by having an XRPD diffractogram comprising peaks at 5.20, 7.33, 10.29, 10.90, 11.15, 14.27, 16.51, and 31.94±0.2° 2θ. The XRPD diffractogram may be as depicted in FIG. 3.

Preferably the crystalline form C3 of (9-[(R)-2-[[(S)-[[(S)-1-(isopropoxy carbonyl) ethyl] amino] phenoxyphosphinyl] methoxy]propyl] adenine hemifumarate, has a crystalline purity of at least 80%, more preferably at least 90%, more preferably at least 95%, most preferably at least 99% by weight.

The invention encompasses a process for preparing the crystalline Form C3 of (9-[(R)-2-[[(S)-[[(S)-1-(isopropoxy carbonyl) ethyl] amino] phenoxyphosphinyl] methoxy]propyl] adenine hemi fumarate comprising: drying crystalline Form C2 of (9-[(R)-2-[[(S)-[[(S)-1-(isopropoxy carbonyl) ethyl] amino] phenoxyphosphinyl] methoxy]propyl] adenine hemi fumarate to obtain a solid.

Preferably, the drying is for about 30 minutes to about 24 hours. More preferably, drying is about 30 minutes to about 10 hours Preferably, the drying is performed at a temperature of about 50° C. to about 150° C. More preferably, drying is performed at a temperature of about 80° C. to about 120° C. Preferably, the drying is performed under vacuum.

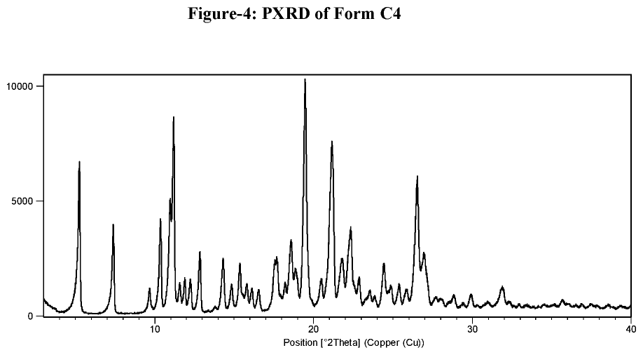

The invention encompasses a crystalline form of (9-[(R)-2-[[(S)-[[(S)-1-(isopropoxy carbonyl) ethyl] amino] phenoxyphosphinyl] methoxy]propyl] adenine hemifumarate, referred to as “Form C4”, characterized by having an XRPD diffractogram comprising peaks at 5.22, 7.36, 9.66, 10.33, 12.22, 19.44, 24.40, 26.47 and 31.83±0.2° 2θ. The XRPD diffractogram may be as depicted in FIG. 4.

Preferably the crystalline Form C4 of (9-[(R)-2-[[(S)-[[(S)-1-(isopropoxy carbonyl) ethyl] amino] phenoxyphosphinyl] methoxy]propyl] adenine hemifumarate, has a crystalline purity of at least 80%, more preferably at least 90%, more preferably at least 95%, most preferably at least 99% by weight.

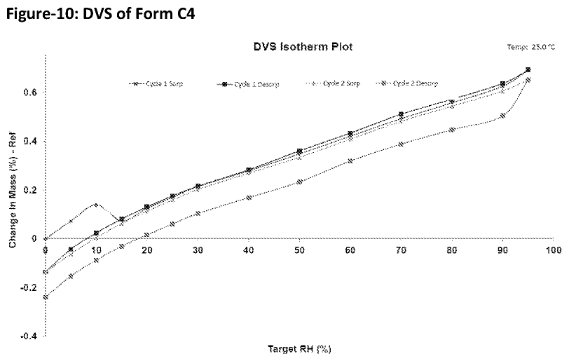

FIG. 10 illustrates a dynamic vapor sorption (DVS) isotherm profile of Form C4 of (9-[(R)-2-[[(S)-[[(S)-1-(isopropoxycarbonyl)ethyl]amino] phenoxyphosphinyl] methoxy]propyl] adenine hemifumarate , according to another embodiment. For the DVS measurement a sample of crystalline Form C4 was cycled through changing humidity conditions to determine its hygroscopicity. The sample was analyzed using a Surface Measurement System DVS-1 Dynamic Vapor Sorption System. About 100 mg of crystalline Form C4 was placed into a mesh vapor sorption balance pan and loaded into a dynamic vapor sorption balance as part of the

Surface Measurement System. Data was collected in 1-minute intervals. Nitrogen was used as the carrier gas. The sampled crystalline Form C4 was subjected to a ramping profile from 0-95% relative humidity (RH) at 5 and 10% increments, maintaining the sample at each step until a stable weight had been achieved (99.5% step completion). After completion of the Sorption cycle, the sample was dried using the same procedure, but all the way down to 95% RH to 30% RH (10% RH interval) and from 30% RH to 5% RH (5% RH interval). The weight change during the Sorption/desorption cycles were plotted, allowing for the hygroscopic nature of the sample to be determined.

As shown in FIG. 10, crystalline Form C4 appears to be non-hygroscopic. A small increase in mass of about 1.7% was observed between 0% and 95% RH during the Sorption cycle. In addition, a very small hysteresis was observed between sorption and desorption cycles. The XRPD pattern of crystalline Form C4, post DVS analysis being similar to its pre-DVS XRPD pattern shown in FIG. 4 indicates that no change in the crystalline Form C4 occurred during DVS.

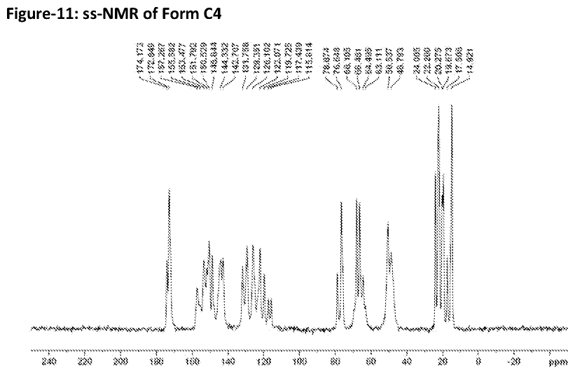

Crystalline Form C4 of (9-[(R)-2-[[(S)-[[(S)-1-(isopropoxy carbonyl) ethyl] amino] phenoxyphosphinyl] methoxy]propyl] adenine hemifumarate, is further characterized by having ss ¹³C NMR spectra as depicted in FIG. 11. The samples were analyzed in a JEOL ECX 400 spectrometer on a 4 mm MAS probe at a spinning frequency of 8 KHz.

The invention encompasses a process for preparing the crystalline Form C4 of (9-[(R)-2-[[(S)-[[(S)-1-(isopropoxy carbonyl) ethyl] amino] phenoxyphosphinyl] methoxy]propyl] adenine hemi fumarate comprising: storing crystalline Form C2 of (9-[(R)-2-[[(S)-[[(S)-1-(isopropoxy carbonyl) ethyl] amino] phenoxyphosphinyl] methoxy]propyl] adenine hemifumarate under suitable conditions to obtain a solid.

Preferably, the storing is for about 1 day to about 15 days. More preferably, storing is about 5 days to about 12 days. Preferably, the storing is performed at a temperature of about −10° C. to about 15° C. More preferably, storing is performed at a temperature of about 0° C. to about 10° C. Preferably, the crystal Form C2 is stored at about 2° C. to about 8° C. for a period of about 8 days to about 10 days to obtain Form C4.

In yet an alternative embodiment, the process for preparing the crystalline Form C4 of (9-[(R)-2-[[(S)-[[(S)-1-(isopropoxy carbonyl) ethyl] amino] phenoxyphosphinyl] methoxy]propyl] adenine hemifumarate comprises: dissolving (9-[(R)-2-[[(S)-[[(S)-1-(isopropoxy carbonyl) ethyl] amino] phenoxyphosphinyl] methoxy]propyl] adenine hemifumarate in a solvent selected from the group comprising of ethanol, methanol, isopropyl alcohol (IPA) and or mixture thereof; removing the solvent from the reaction mass; adding a water-immiscible organic solvent to obtain a precipitate; stirring for sufficient time to obtain a solid and drying the solid.

Preferably, the removal of solvent is by evaporation, more preferably under reduced pressure, to a temperature of about 40° C. to about 70° C., preferably about 50° C. to about 60° C.

Preferably, the water-immiscible organic solvent is selected from the group comprising of halogenated aliphatic hydrocarbon, aromatic hydrocarbon, ester, ethers, halogenated aromatic hydrocarbon, and mixtures thereof. Preferably, the ester is selected from the group comprising of ethyl acetate, methyl acetate, butyl acetate, isopropyl acetate, and mixtures thereof. Preferably, the ether is selected from the group comprising of petroleum ether, diisopropyl ether and diethyl ether. Preferably, the halogenated aromatic hydrocarbon is chloro benzene. Preferably, the aromatic hydrocarbon is toluene and xylene. Preferably, the halogenated aliphatic hydrocarbon is selected from the group consisting of dichloromethane, chloroform, and mixtures thereof. Preferably, the water-immiscible organic solvent is selected from the group consisting of petroleum ether, dichloromethane, toluene, and mixtures thereof. More preferably, the water-immiscible organic solvent is petroleum ether.

Preferably, water -immiscible organic solvent is added at a temperature of about 50° C. to about 60° C., more preferably at about 55° C.

Preferably, reaction mass is stirred for about 5 hours to about 30 hours, more preferably for about 10 hours to about 25 hours at about 10° C. to about 40° C., more preferably at about 20° C. to about 30° C.

Preferably, isolation of the solid is done by filtration. Preferably, the isolated solid is dried.

The drying may be done in a vacuum oven to obtain Form C4. Preferably, the drying is for about 30 minutes to about 5 hours. Preferably, the drying is performed at a temperature of about 30° C. to about 50° C.

In yet an alternative embodiment, the process for preparing the crystalline Form C4 of (9-[(R)-2-[[(S)-[[(S)-1-(isopropoxy carbonyl) ethyl] amino] phenoxyphosphinyl] methoxy]propyl] adenine hemifumarate comprises: dissolving (9-[(R)-2-[[(S)-[[(S)-1-(isopropoxy carbonyl) ethyl] amino] phenoxyphosphinyl] methoxy]propyl] adenine hemifumarate in a water or a mixture of water and water miscible solvent; cooling the reaction mass; optionally adding water to obtain a precipitate; stirring for sufficient time to obtain a solid and drying the solid.

Preferably, the water-miscible organic solvent is selected from the group comprising of acetone, acetonitrile, THF, DMF, DMSO, dioxane, ethanol, methanol and isopropyl alcohol and the like.

Preferably, the solid is dissolved at a temperature ranging from 25° C. to about reflux temperature of the solvent used; more preferably at about 50° C. to about 80° C.

Typically, following the heating step, the solution is cooled. Preferably, cooling is to about room temperature. Preferably, cooling is to a temperature of about 20° C. to about 30° C., more preferably, cooling is to a temperature of about 25° C. to about 30° C.

Preferably, reaction mass is stirred for about 1 hour to about 10 hours, more preferably for about 2 hours to about 5 hours at about 20° C. to about 30° C., more preferably at about 25° C. to about 30° C., prior to the filtration.

Preferably, isolation of the solid is done by filtration. Preferably, the isolated solid is dried.

The drying may be done in a vacuum oven to obtain Form C4. Preferably, the drying is for about 2 hours to about 10 hours. More preferably, drying is about 5 hours to about 8 hours. Preferably, the drying is performed at a temperature of about 30° C. to about 70° C. More preferably, drying is performed at a temperature of about 40° C. to about 50° C. Preferably, the drying is performed under vacuum to obtain Form C4.

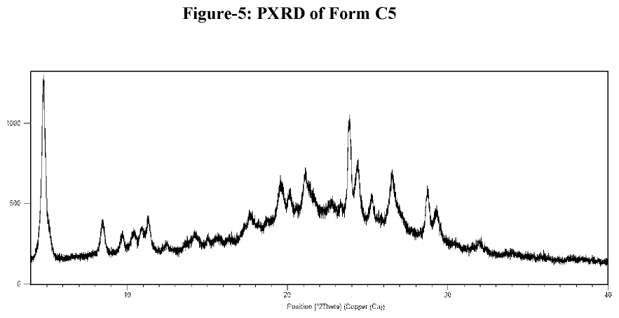

The invention encompasses a crystalline form of (9-[(R)-2-[[(S)-[[(S)-1-(isopropoxy carbonyl) ethyl] amino] phenoxyphosphinyl] methoxy]propyl] adenine hemifumarate ethyl formate solvate, referred to as “Form C5”, characterized by having an XRPD diffractogram comprising peaks at 4.79, 9.46, 9.67, 11.39, 19.57, 23.80, 24.34, 25.23 and 26.53±0.2° 2θ. The XRPD diffractogram may be as depicted in FIG. 5.

Preferably the crystalline Form C5 of (9-[(R)-2-[[(S)-[[(S)-1-(isopropoxy carbonyl) ethyl] amino] phenoxyphosphinyl] methoxy]propyl] adenine hemifumarate, has a crystalline purity of at least 80%, more preferably at least 90%, more preferably at least 95%, most preferably at least 99% by weight.

The invention encompasses a process for preparing the crystalline Form C5 of (9-[(R)-2-[[(S)-[[(S)-1-(isopropoxy carbonyl) ethyl] amino] phenoxyphosphinyl] methoxy]propyl] adenine hemi fumarate comprising: dissolving (9-[(R)-2-[[(S)-[[(S)-1-(isopropoxy carbonyl) ethyl] amino] phenoxyphosphinyl] methoxy]propyl] adenine hemifumarate in ethyl formate; removing the solvent from the reaction mass to obtain a solid and drying the solid.

Preferably, the removal is by evaporation, more preferably under reduced pressure, to a temperature of about 40° C. to about 70° C., preferably about 50° C. to about 60° C.

Preferably, isolation of the solid is done by filtration. Preferably, the isolated solid is dried.

Preferably, the drying is for about 30 minutes to about 20 hours. More preferably, drying is about 5 hours to about 10 hours. Preferably, the drying is performed at a temperature of about 30° C. to about 80° C. More preferably, drying is performed at a temperature of about 40° C. to about 60° C. Preferably, the drying is performed under vacuum to obtain Form C5.

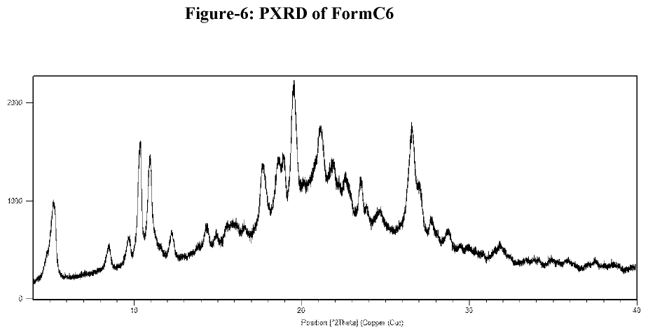

The invention encompasses a crystalline form of (9-[(R)-2-[[(S)-[[(S)-1-(isopropoxy carbonyl) ethyl] amino] phenoxyphosphinyl] methoxy]propyl] adenine hemifumarate, referred to as “Form C6”, characterized by having an XRPD diffractogram comprising peaks at 5.17, 8.46, 9.66, 10.34, 10.95, 17.69, 19.48 and 26.54±0.2° 2θ. The XRPD diffractogram may be as depicted in FIG. 6.

Preferably the crystalline Form C6 of (9-[(R)-2-[[(S)-[[(S)-1-(isopropoxy carbonyl) ethyl] amino] phenoxyphosphinyl] methoxy]propyl] adenine hemifumarate, has a crystalline purity of at least 80%, more preferably at least 90%, more preferably at least 95%, most preferably at least 99% by weight.

The invention encompasses a process for preparing the crystalline Form C6 of (9-[(R)-2-[[(S)-[[(S)-1-(isopropoxy carbonyl) ethyl] amino] phenoxyphosphinyl] methoxy]propyl] adenine hemifumarate comprising: drying crystalline Form C5 of (9-[(R)-2-[[(S)-[[(S)-1-(isopropoxy carbonyl) ethyl] amino] phenoxyphosphinyl] methoxy]propyl] adenine hemifumarate to obtain a solid.

Preferably, the drying is for about 1 hour to about 24 hours. More preferably, drying is about 5 hours to about 10 hours Preferably, the drying is performed at a temperature of about 30° C. to about 100° C. More preferably, drying is performed at a temperature of about 40° C. to about 60° C. Preferably, the drying is performed under vacuum.

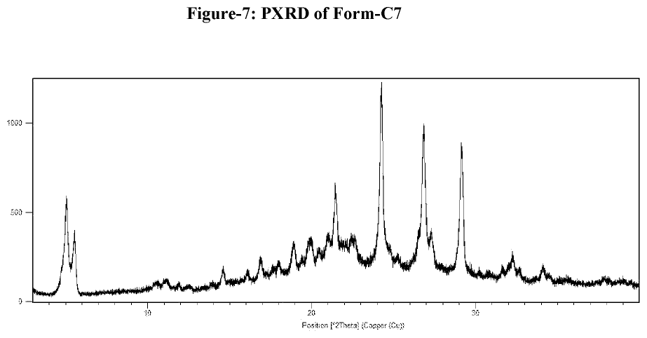

The invention encompasses a crystalline form of (9-[(R)-2-[[(S)-[[(S)-1-(isopropoxy carbonyl) ethyl] amino] phenoxyphosphinyl] methoxy]propyl] adenine hemifumarate methyl acetate solvate, referred to as “Form C7”, characterized by having an XRPD diffractogram comprising peaks at 5.02, 5.51, 16.88, 21.44, 24.23, 26.80 and 29.11±0.2° 2θ. The XRPD diffractogram may be as depicted in FIG. 7.

Preferably the crystalline Form C7 of (9-[(R)-2-[[(S)-[[(S)-1-(isopropoxy carbonyl) ethyl] amino] phenoxyphosphinyl] methoxy]propyl] adenine hemifumarate, has a crystalline purity of at least 80%, more preferably at least 90%, more preferably at least 95%, most preferably at least 99% by weight.

The invention encompasses a process for preparing the crystalline Form C7 of (9-[(R)-2-[[(S)-[[(S)-1-(isopropoxy carbonyl) ethyl] amino] phenoxyphosphinyl] methoxy]propyl] adenine hemi fumarate comprising: dissolving (9-[(R)-2-[[(S)-[[(S)-1-(isopropoxy carbonyl) ethyl] amino] phenoxyphosphinyl] methoxy]propyl] adenine hemifumarate in methyl acetate; removing the solvent from the reaction mass to obtain a solid and drying the solid.

Preferably, the removal is by evaporation, more preferably under reduced pressure, to a temperature of about 40° C. to about 70° C., preferably about 50° C. to about 60° C.

Preferably, isolation of the solid is done by filtration. Preferably, the isolated solid is dried.

Preferably, the drying is for about 1 hour to about 30 hours. More preferably, drying is about 10 hours to about 20 hours. Preferably, the drying is performed at a temperature of about 20° C. to about 50° C. More preferably, drying is performed at a temperature of about 30° C. to about 40° C. Preferably, the drying is performed under vacuum to obtain Form C7.

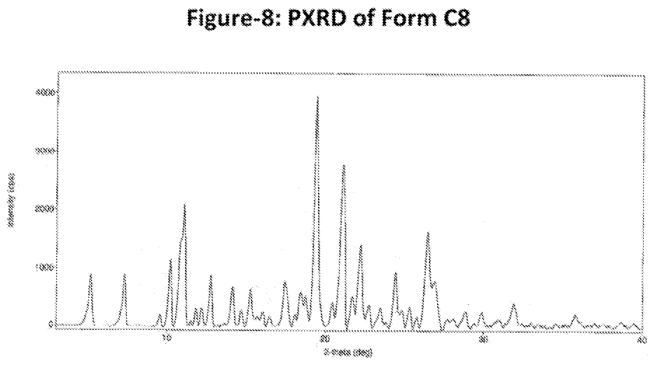

The invention encompasses a crystalline form of (9-[(R)-2-[[(S)-[[(S)-1-(isopropoxy carbonyl) ethyl] amino] phenoxyphosphinyl] methoxy]propyl] adenine hemifumarate, referred to as “Form C8”, characterized by having an XRPD diffractogram comprising peaks at 11.07, 19.38, 21.12, 22.20, 24.39 and 26.43±0.2° 2θ. The XRPD diffractogram may be as depicted in FIG. 8.

Preferably the crystalline Form C8 of (9-[(R)-2-[[(S)-[[(S)-1-(isopropoxy carbonyl) ethyl] amino] phenoxyphosphinyl] methoxy]propyl] adenine hemifumarate, has a crystalline purity of at least 80%, more preferably at least 90%, more preferably at least 95%, most preferably at least 99% by weight.

The invention encompasses a process for preparing the crystalline Form C8 of (9-[(R)-2-[[(S)-[[(S)-1-(isopropoxy carbonyl) ethyl] amino] phenoxyphosphinyl] methoxy]propyl] adenine hemifumarate comprising: mixing (9-[(R)-2-[[(S)-[[(S)-1-(isopropoxy carbonyl) ethyl] amino] phenoxyphosphinyl] methoxy]propyl] adenine in water; heating at elevated temperature; adding fumaric acid; slowly cooling the solution to a temperature of less than

20° C.; filtering off the precipitated solid and drying it.

Preferably, heating is to a temperature of about RT to about 70° C., more preferably, to a temperature of about 30° C. to about 60° C., most preferably, to a temperature of about 40° C. to about 50° C. to obtain a solution.

Typically, following the heating step and after the addition of fumaric acid, the solution is cooled. Preferably, cooling is to about room temperature and further cooling is performed. Preferably, cooling is to a temperature of about 20° C. to about −10° C., more preferably, cooling is to a temperature of about 5° C. to about 0° C.

Preferably, the reaction mass is stirred for about 20 minutes to about 50 minutes, more preferably, for about 30 minutes to about 40 minutes prior to the filtration.

Preferably, the drying is for about 2 hours to about 10 hours. More preferably, drying is about 5 hours to about 8 hours. Preferably, the drying is performed at a temperature of about 30° C. to about 70° C. More preferably, drying is performed at a temperature of about 40° C. to about 50° C. Preferably, the drying is performed under vacuum to obtain Form C8.

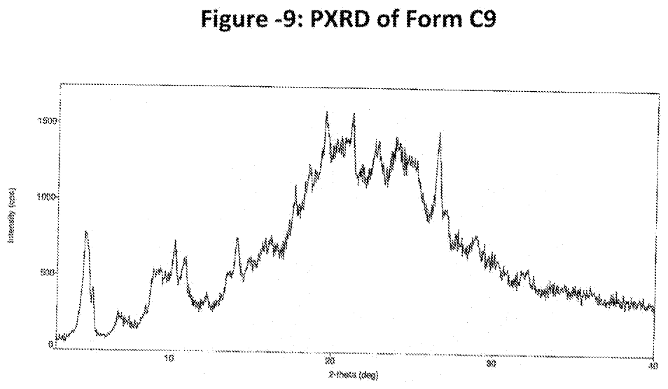

The invention encompasses a crystalline form of (9-[(R)-2-[[(S)-[[(S)-1-(isopropoxy carbonyl) ethyl] amino] phenoxyphosphinyl] methoxy]propyl] adenine monofumarate, referred to as “Form C9”, characterized by having an XRPD diffractogram comprising peaks at 4.8, 8.6, 10.91, 14.06, 16.18, 17.57, 19.45, 21.13, and 26.53±0.2° 2θ. The XRPD diffractogram may be as depicted in FIG. 9.

The invention encompasses a process for preparing the crystalline Form C9 of (9-[(R)-2-[[(S)-[[(S)-1-(isopropoxy carbonyl) ethyl] amino] phenoxyphosphinyl] methoxy]propyl] adenine monofumarate comprising: mixing (9-[(R)-2-[[(S)-[[(S)-1-(isopropoxy carbonyl) ethyl] amino] phenoxyphosphinyl] methoxy]propyl] adenine in a water immiscible solvent; adding fumaric acid; heating at elevated temperature; slowly cooling the solution to a temperature of less than 30° C.; filtering off the precipitated solid and drying it.

Preferably, water immiscible solvent is selected from but not limited to the chlorinated solvents such as dichloromethane, dichloroethane, trichloroethane, chloroform, carbon tetrachloride & trichloroethylene.

Preferably, heating is to a temperature of about 25° C. to about 40° C., more preferably, to a temperature 40° C. to obtain a solution.

Typically, following the heating step, the solution is cooled. Preferably, cooling is to about room temperature. Preferably, cooling is to a temperature of about 20° C. to about 30° C., more preferably, cooling is to a temperature of about 25° C. to about 30° C.

Preferably, the reaction mass is stirred for about 30 minutes to about 90 minutes, more preferably, for about 40 minutes to about 60 minutes prior to the filtration.

Preferably, the drying is for about 2 hours to about 10 hours. More preferably, drying is about 5 hours to about 8 hours. Preferably, the drying is performed at a temperature of about 30° C. to about 70° C. More preferably, drying is performed at a temperature of about 40° C. to about 50° C. Preferably, the drying is performed under vacuum to obtain Form C9.

Those skilled in the art would recognize that crystalline Forms 1 to 9 of the present invention may be further characterized by other methods including, but not limited to DSC, TGA, IR, solid state NMR and Raman spectroscopy.

The (9-[(R)-2-[[(S)-[[(S)-1-(isopropoxy carbonyl) ethyl] amino] phenoxyphosphinyl] methoxy]propyl] adenine hemifumarate, used in the preparation of crystalline forms C1, C2, C5 and C7 may be in any polymorphic form or in a mixture of any polymorphic forms.

The (9-[(R)-2-[[(S)-[[(S)-1-(isopropoxy carbonyl) ethyl] amino] phenoxyphosphinyl] methoxy]propyl] adenine, used in the preparation of crystalline forms C8 and C9 may be in any polymorphic form or in a mixture of any polymorphic forms.

The (9-[(R)-2-[[(S)-[[(S)-1-(isopropoxy carbonyl) ethyl] amino] phenoxyphosphinyl] methoxy]propyl] adenine, used for the above process, as well as for the following processes, describe in this application can be obtained by any method known to a skilled artisan.

The process of invention may be used as a method for purifying any form of (9-[(R)-2-[[(S)-[[(S)-1-(isopropoxy carbonyl) ethyl] amino] phenoxyphosphinyl] methoxy]propyl] adenine or pharmaceutically acceptable salts thereof, as well as for the preparation of the new polymorphic forms.

According to another aspect of the present invention, there is provided a pharmaceutical composition comprising polymorphic forms of (9-[(R)-2-[[(S)-[[(S)-1-(isopropoxy carbonyl) ethyl] amino] phenoxyphosphinyl] methoxy]propyl] adenine or pharmaceutically acceptable salts thereof as described above, together with one or more pharmaceutically acceptable excipients. The 9-[(R)-2-[[(S)-[[(S)-1-(isopropoxy carbonyl) ethyl] amino] phenoxyphosphinyl] methoxy]propyl] adenine or pharmaceutically acceptable salts thereof, used in the preparation of pharmaceutical compositions may substantially consist of one of forms C1, C2, C3, C4, C5, C6, C7, C8 or C9 as described above, or may substantially consist of a combination of two or more of said forms.

According to yet another aspect of the present invention there is provided use of polymorphic Forms of 9-[(R)-2-[[(S)-[[(S)-1-(isopropoxy carbonyl) ethyl] amino] phenoxyphosphinyl] methoxy]propyl] adenine or pharmaceutically acceptable salts thereof as described above, in the preparation of a medicament useful in treating or preventing HIV infection and chronic hepatitis B.

According to yet another aspect of the present invention there is provided a method for the prevention or treatment of HIV infection and chronic hepatitis B, which method comprises administering crystalline Form C4 of (9-[(R)-2-[[(S)-[[(S)-1-(isopropoxy carbonyl) ethyl] amino] phenoxyphosphinyl] methoxy]propyl] adenine hemifumarate, in therapeutically effective amounts to a patient in need thereof.

The invention will now be further described by the following examples, which are illustrative rather than limiting.

### EXAMPLES

### Example 1

### Process to Prepare Form C1

(9-[(R)-2-[[(S)-[[(S)-1-(isopropoxy carbonyl) ethyl] amino] phenoxyphosphinyl] methoxy]propyl] adenine hemifumarate (6 g) dissolved in methanol (60 ml) at 25-30° C. To the above clear solution was added petroleum ether (12 ml) and evaporated the solvent completely at 50-55° C. under vacuum. The solids were dried under vacuum at 35-40° C. for about 1 hour. Crystalline Form C1 thus obtained was analyzed by XRD, which is substantially as shown in FIG. 1.

Yield: 4.2 g (70% w/w)

### Example 2

### Process to Prepare Form C2

(9-[(R)-2-[[(S)-[[(S)-1-(isopropoxy carbonyl) ethyl] amino] phenoxyphosphinyl] methoxy]propyl] adenine hemifumarate (6 g) was dissolved in methanol (60 ml) at 25-30° C. To the above clear solution was added petroleum ether (12 ml) and the solvent was removed completely at 50-55° C. under vacuum. The solids were dried under vacuum at 25-30° C. for about 15 hours. Crystalline Form C2 thus obtained was analyzed by XRD which is substantially as shown in FIG. 2.

Yield—5.1 g (85% w/w)

### Example 3

### Process to Prepare Form C3

Crystalline Form C2 was dried under vacuum at 95-100° C. for about 30 minutes. Crystalline Form C3 thus obtained was analyzed by XRD which is substantially as shown in FIG. 3.

### Example 4

### Process to Prepare Form C4

Crystalline Form C2 was kept under dry condition at 2-8° C. for about ten days and then resulting solid was analyzed by XRD which is substantially as shown in FIG. 4.

### Example 5

### Process to Prepare Form C5

(9-[(R)-2-[[(S)-[[(S)-1-(isopropoxy carbonyl) ethyl] amino] phenoxyphosphinyl] methoxy]propyl] adenine hemifumarate (2 g) was dissolved in ethyl formate (100 ml) at 55-60° C. The solvent was removed completely at 55-60° C. under vacuum. The resulting solids were dried under vacuum at 50° C. for about 7 hrs. Crystalline Form C5 thus obtained was analyzed by XRD which is substantially as shown in FIG. 5.

Yield—1.9 g (95% w/w)

### Example 6

### Process to Prepare Form C6

Crystalline Form C5 was dried at 50° C. under vacuum for 7 hours and then resulting solid was analyzed by XRD which is substantially as shown in FIG. 6.

### Example 7

### Process to Prepare Form C7

(9-[(R)-2-[[(S)-[[(S)-1-(isopropoxy carbonyl) ethyl] amino] phenoxyphosphinyl] methoxy]propyl] adenine hemifumarate (1 g) was dissolved in methyl acetate (70 ml) at 55-60° C. The solvent was removed completely at 50-55° C. under vacuum. The resulting solids were dried under vacuum at 25-30° C. for about 15 hrs. Crystalline Form C7 thus obtained was analyzed by XRD which is substantially as shown in FIG. 7.

Yield—0.6 g, (60% w/w)

### Example 8

### Process to Prepare Form C8

(9-[(R)-2-[[(S)-[[(S)-1-(isopropoxy carbonyl) ethyl] amino] phenoxyphosphinyl] methoxy]propyl] adenine (5 g, 0.010 moles) was stirred in water (50 ml) at 25-30° C. The reaction mass was heated to 55-60° C. Fumaric acid (0.61 g, 0.005 moles) was added. The reaction mass was stirred for 10 minutes and cooled to 25-30° C. The reaction mass was further chilled to 0-5° C., stirred for 30 minutes. The solid was isolated by filtration and dried under vacuum at 50° C. for about 2-3 hours. Crystalline Form C8 thus obtained was analyzed by XRD which is substantially as shown in FIG. 8.

Yield—4.0g, (80% w/w)

### Example 9

### Process to Prepare Form C9

(9-[(R)-2-[[(S)-[[(S)-1-(isopropoxy carbonyl) ethyl] amino] phenoxyphosphinyl] methoxy]propyl] adenine (5 g, 0.010 moles) was stirred in MDC (50 ml) at 25-30° C. Fumaric acid (0.61 g, 0.005 moles) was added. The reaction mass was heated to 40-45° C. and maintained for 10-15 minutes. The reaction mass was cooled to 25-30° C. and stirred for about 60 minutes. The solid was isolated by filtration and dried under vacuum at 50° C. for about 2-3 hours. Crystalline Form C9 thus obtained was analyzed by XRD which is substantially as shown in FIG. 9.

Yield—4.0 g, (80% w/w)

### Example 10

### Process to Prepare Form C4

(9-[(R)-2-[[(S)-[[(S)-1-(isopropoxy carbonyl) ethyl] amino] phenoxyphosphinyl] methoxy]propyl] adenine hemifumarate (6 g) was dissolved in methanol (60 ml) at 25-30° C. The solvent was removed completely at 50-55° C. under vacuum. The residue was stirred in petroleum ether (60 ml) for about 10-24 hours at 25-30° C. The solids were isolated by filtration and dried under vacuum at 35-40° C. for about 1 hour. Crystalline Form C4 thus obtained was analyzed by XRD which is substantially as shown in FIG. 4.

Yield—5.5 g, (91.66% w/w)

### Example 11

### Process to Prepare Form C4

(9-[(R)-2-[[(S)-[[(S)-1-(isopropoxy carbonyl) ethyl] amino] phenoxyphosphinyl] methoxy]propyl] adenine hemifumarate (5 g) was dissolved in water (100 ml) at 75-80° C. The reaction mass was slowly cooled to 25-30° C. and stirred further for 2 hours. The solids were isolated by filtration and dried under vacuum at 35-40° C. for about 5 hours. Crystalline Form C4 thus obtained was analyzed by XRD, DVS and NMR.

### Example 12

### Process to Prepare Form C4

(9-[(R)-2-[[(S)-[[(S)-1-(isopropoxy carbonyl) ethyl] amino] phenoxyphosphinyl] methoxy]propyl] adenine hemifumarate (10 g) was dissolved in a mixture of DMF: water (5:25 ml) at 50-60° C.

The reaction mass was slowly cooled to 35° C. and water (25 ml) was added. The reaction mass was stirred further for 3 to 4 hours. The solids were isolated by filtration and dried under vacuum at 35-40° C. for about 6 hours. Crystalline Form C4 thus obtained was analyzed by XRD, DVS and NMR.

Yield—8.4 g, (84% w/w)

### Example 13

### Process to Prepare Form C4

(9-[(R)-2-[[(S)-[[(S)-1-(isopropoxy carbonyl) ethyl] amino] phenoxyphosphinyl] methoxy]propyl] adenine hemifumarate (750 g) was dissolved in a mixture of DMF:water (375:1875 ml) at 50-60° C. The reaction mass was slowly cooled to 35° C. and water (1875 ml) was added. The reaction mass was stirred further for 3 to 4 hours. The solids were isolated by filtration and dried under vacuum at 35-40° C. for about 6 hours. Crystalline Form C4 thus obtained was analyzed by XRD, DVS and NMR.

Yield—592 g, (78.9% w/w)

### Methods

### Dynamic Vapor Sorption (DVS)

1. The hygroscopicity was studied at 25° C. using an SMS DVS intrinsic analyser.
2. About 100 mg of sample was placed in a tared sample holder at an initial ambient room humidity.
3. A total wet/dry nitrogen flow rate of 270 cc/min was used throughout the study.
4. Solids were studied by performing one full cycle of the following program: 300 minutes of drying at 25° C. under dry N2, followed by settings of 0, 5, 10, 15, 20, 25, 30, 40, 50, 60, 70, 80, 90 and 95% RH, with exposure time at each humidity set point dependent upon 99.5% confidence in the F1 fit model or 60 minutes. The maximum time allowed at any one humidity set point was 60 minutes. Followed by decreasing 95% RH to 30% RH (10% RH interval) and from 30% RH to 5% RH (5% RH interval). Two cycles of sorption and desorption were done. The sample was maintained under dry N2 after the cycle was completed.
5. Percent weight gain was calculated based on the dry weight basis.

1. A crystalline form of (9-[(R)-2-[[(S)-[[(S)-1-(isopropoxycarbonyl)ethyl] amino]phenoxyphosphinyl]methoxy]propyl] adenine hemifumarate or (9-[(R)-2-[[ (S)-[[ (S)-1-(isopropoxycarbonyl)ethyl] amino]phenoxy phosphinyl]methoxy]propyl] adenine monofumarate, wherein the crystalline form is selected from the group consisting of Form C1, Form C2, Form C3, Form C4, Form C5, Form C6, Form C7, Form C8 and Form C9.

2. The crystalline form according to claim 1, wherein the crystalline form is Form C1 of (9-[(R)-2-[[(S)-[[(S)-1-(isopropoxycarbonyl)ethyl] amino]phenoxyphosphinyl]methoxy]propyl] adenine hemifumarate, characterized by having an XRPD diffractogram comprising peaks at 5.22, 10.34, 10.94, 17.7, 18.56, 19.48, 21.10 and 26.54±0.2° 2θ, substantially as depicted in FIG. 1.

3. The crystalline form according to claim 1, wherein the crystalline form is Form C2 of (9-[(R)-2-[[(S)-[[(S)-1-(isopropoxycarbonyl)ethyl] amino]phenoxyphosphinyl]methoxy]propyl]adenine hemifumarate, characterized by having an XRPD diffractogram comprising peaks at 5.30, 7.47, 10.42, 11.02, 17.799, 18.68, 19.58, 21.20,21.86, 26.54 and 31.94±0.2° 2θ, substantially as depicted in FIG. 2.

4. The crystalline form according to claim 1, wherein the crystalline form is Form C3 of (9-[(R)-2-[[(S)-[[(S)-1-(isopropoxycarbonyl)ethyl] amino]phenoxy phosphinyl]methoxy]propyl] adenine hemifumarate, characterized by having an XRPD diffractogram comprising peaks at 5.20, 7.33, 10.29, 10.90, 11.15, 14.27, 16.51, and 31.94±0.2° 2θ, substantially as depicted in FIG. 3.

5. The crystalline form according to claim 1, wherein the crystalline form is Form C4 of (9-[(R)-2-[[(S)-[[(S)-1-(isopropoxycarbonyl)ethyl] amino]phenoxyphosphinyl]methoxy]propyl] adenine hemifumarate, characterized by having an XRPD diffractogram comprising peaks at 5.22, 7.36, 9.66, 10.33, 12.22, 19.44, 24.40, 26.47 and 31.83±0.2° 2θ, substantially as depicted in FIG. 4.

6. The crystalline form according to claim 1, wherein the crystalline form is:
Form C5 of (9-[(R)-2-[[(S)-[[(S)-1-(isopropoxycarbonyl)ethyl] amino]phenoxyphosphinyl]methoxy]propyl]adenine hemifumarate, an ethyl formate solvate, characterized by having an XRPD diffractogram comprising peaks at 4.79, 9.46, 9.67, 11.39, 19.57, 23.80, 24.34, 25.23 and 26.53±0.2° 2θ, substantially as depicted in FIG. 5;
Form C6 of (9-[(R)-2-[[(S)-[[(S)-1-(isopropoxycarbonyl)ethyl] amino]phenoxyphosphinyl]methoxy]propyl]adenine hemifumarate ethyl formate solvate as claimed in claim 1, characterized by having an XRPD diffractogram comprising peaks at 5.17, 8.46, 9.66, 10.34, 10.95, 17.69, 19.48 and 26.54±0.2° 2θ, substantially as depicted in FIG. 6; or
Form C7 of (9-[(R)-2-[[(S)-[[(S)-1-(isopropoxycarbonyl)ethyl] amino]phenoxyphosphinyl]methoxy]propyl] adenine hemifumarate, a methyl acetate solvate as claimed in claim 1, characterized by having an XRPD diffractogram comprising peaks at 5.02, 5.51, 16.88, 21.44, 24.23, 26.80 and 29.11±0.2° 2θ, substantially as depicted in FIG. 7.

7-8. (canceled)

9. The crystalline form according to claim 1, wherein the crystalline form is Form C8 of (9-[(R)-2-[[(S)-[[(S)-1-(isopropoxycarbonyl)ethyl] amino]phenoxyphosphinyl]methoxy]propyl] adenine hemifumarate, characterized by having an XRPD diffractogram comprising peaks at 11.07, 19.38, 21.12, 22.20, 24.39 and 26.43±0.2° 2θ, substantially as depicted in FIG. 8.

10. The crystalline form according to claim 1, wherein the crystalline form is Form C9 of (9-[(R)-2-[[(S)-[[(S)-1-(isopropoxycarbonyl)ethyl] amino]phenoxyphosphinyl]methoxy]propyl] adenine monofumarate, characterized by having an XRPD diffractogram comprising peaks at 4.8, 8.6, 10.91, 14.06, 16.18, 17.57, 19.45, 21.13, and 26.53±0.2° 2θ, substantially as depicted in FIG. 9.

11. A process for preparing crystalline Form C1 as claimed in claim 2, wherein, the process comprises, dissolving (9-[(R)-2-[[(S)-[[(S)-1-(isopropoxycarbonyl)ethyl]amino] phenoxyphosphinyl] methoxy]propyl] adenine hemifumarate in a solvent selected from the group comprising of ethanol, methanol, isopropyl alcohol (IPA) and or mixture thereof; adding a water-immiscible organic solvent to obtain a precipitate; and removing the solvent from the reaction mass to obtain a solid and drying the solid at 35° C. to 40° C. for about 1 hour .

12. A process for preparing crystalline Form C2 as claimed in claim 3, wherein, the process comprises, dissolving (9-[(R)-2-[[(S)-[[(S)-1-(isopropoxycarbonyl) ethyl] amino] phenoxyphosphinyl] methoxy]propyl] adenine hemifumarate in solvent selected from the group comprising of ethanol, methanol, isopropyl alcohol (IPA) and or mixture thereof; adding a water-immiscible organic solvent to obtain a precipitate; removing the solvent from the reaction mass to obtain a solid and drying the solid at 30° C. to 50° C. for about 15 hours.

13. A process for preparing crystalline Form C3 as claimed in claim 4, wherein, the process comprises, drying crystalline Form C2 of (9-[(R)-2-[[(S)-[[(S)-1-(isopropoxy carbonyl) ethyl] amino] phenoxyphosphinyl] methoxy]propyl] adenine hemi fumarate at a temperature of about 50° C. to about 150° C. to obtain a solid.

14. A process for preparing crystalline Form C4 as claimed in claim 5, wherein, the process comprises:
storing crystalline Form C2 of (9-[(R)-2-[[(S)-[[(S)1-(isopropoxy carbonyl) ethyl] amino] phenoxyphosphinyl] methoxy]propyl] adenine hemifumarate at a temperature of about −10° C. to about 15° C. for about 10 days to obtain a solid;
dissolving (9-[(R)-2-[[(S)-[[(S)-1-(isopropoxycarbonyl) ethyl] amino] phenoxyphosphinyl] methoxy]propyl] adenine hemifumarate in a solvent selected from the group comprising of ethanol, methanol, isopropyl alcohol (IPA) and or mixture thereof; removing the solvent from the reaction mass; adding a water-immiscible organic solvent to obtain a precipitate; stirring for sufficient time to obtain a solid and drying the solid at 35° C. to 40° C. for about 1 hour; or
dissolving (9-[(R)-2-[[(S)-[[(S)-1-(isopropoxy carbonyl) ethyl] amino] phenoxyphosphinyl] methoxy]propyl] adenine hemifumarate in a water or a mixture of water and water miscible solvent cooling the reaction mass; optionally adding water to obtain a precipitate; stirring for sufficient time to obtain a solid and drying the solid at 35° C. to 40° C. for about 5 to 6 hours.

15-17. (canceled)

18. A process for preparing crystalline Form C5 as claimed in claim 6, wherein, the process comprises, dissolving (9-[(R)-2-[[(S)-[[(S)-1-(isopropoxycarbonyl)ethyl]amino] phenoxyphosphinyl]methoxy]propyl]adenine hemifumarate in ethyl formate; removing the solvent from the reaction mass to obtain a solid and drying the solid at a temperature of about 30° C. to about 80° C. for about 7 hours.

19. A process for preparing crystalline Form C6 as claimed in claim 6, wherein, the process comprises, drying crystalline Form C5 of (9-[(R)-2-[[(S)-[[(S)-1-(isopropoxycarbonyl)ethyl]amino]phenoxyphosphinyl]methoxy]propyl]adenine hemifumarate at a temperature of about 30° C. to about 100° C. to obtain a solid.

20. A process for preparing crystalline Form C7 as claimed in claim 6, wherein, the process comprises, dissolving (9-[(R)-2-[[(S)-[[(S)-1-(isopropoxycarbonyl)ethyl]amino] phenoxyphosphinyl]methoxy]propyl]adenine hemifumarate in methyl acetate; removing the solvent from the reaction mass to obtain a solid and drying the solid at a temperature of about 20° C. to about 50° C.

21. A process for preparing crystalline Form C8 as claimed in claim 9, wherein, the process comprises, mixing (9-[(R)-2-[[(S)-[[(S)-1-(isopropoxycarbonyl)ethyl]amino] phenoxyphosphinyl]methoxy]propyl]adenine in water; heating at elevated temperature; adding fumaric acid; slowly cooling the solution to a temperature of less than 20° C.; filtering off the precipitated solid and drying the solid at a temperature of about 30° C. to about 70° C.

22. A process for preparing crystalline Form C9 as claimed in claim 10, wherein, the process comprises, mixing (9-[(R)-2-[[(S)-[[(S)-1-(isopropoxycarbonyl)ethyl]amino] phenoxyphosphinyl]methoxy]propyl]adenine in a water immiscible solvent; adding fumaric acid; heating at elevated temperature; slowly cooling the solution to a temperature of less than 30° C.; filtering off the precipitated solid and drying the solid at a temperature of about 30° C. to about 70° C.

23-24. (canceled)

25. The crystalline Form C4 of(9-[(R)-2-[[(S)-[[(S)-1-(isopropoxycarbonyl)ethyl]amino]phenoxyphosphinyl]methoxy]propyl]adenine hemifumarate as claimed in claim 1, wherein the crystalline form is:
characterized by a DVS thermogram, substantially as depicted in FIG. 10; or
characterized by NMR, substantially as depicted in FIG. 11.

26. (canceled)

27. A pharmaceutical composition comprising the crystalline Form C4 of (9-[(R)-2-[[(S)-[[(S)-1-(isopropoxycarbonyl)ethyl]amino]phenoxyphosphinyl] methoxy]propyl]adenine hemifumarate, optionally comprising one or more pharmaceutically acceptable excipients.

28. A method for the prevention or treatment of HIV infection or chronic hepatitis B which method comprises administering crystalline Form C4 of (9-[(R)-2-[[(S)-[[(S)-1-(isopropoxycarbonyl)ethyl]amino]phenoxyphosphinyl]methoxy]propyl]adenine hemifumarate, in therapeutically effective amounts to a patient in need thereof.
